(19) United States
(12) Patent Application Publication
(10) Pub. No.: US 2018/0032631 A1
(43) Pub. Date: Feb. 1, 2018

(54) SYSTEM AND METHODS FOR RETRIEVING DATA USING BOTH PERIODIC AND APERIODIC DATA RETRIEVAL PROCESSES

(71) Applicant: ALQIMI Analytics & Intelligence, LLC, Rockville, MD (US)

(72) Inventors: Walter GREENBERG, Rockville, MD (US); Kevin M. DONOHUE, Rockville, MD (US)

(21) Appl. No.: 15/224,252

(22) Filed: Jul. 29, 2016

(51) Int. Cl. G06F 17/30

(52) U.S. Cl. CPC G06F 17/30941; G06F 17/30864; G06F 17/30938

(57) ABSTRACT

Some embodiments are directed to a method for exchanging data between a user and a data source, the method includes configuring a non-transitory computer readable medium to retrieve data from a data source via a data source query in accordance with data retrieval filters, display options, a first set of options for periodic data retrieval and a second set of options for aperiodic data retrieval specified in a user-defined XML configuration file. Further, the non-transitory computer readable medium utilizes a first application that retrieves data periodically in accordance with the first set of options specified in the user-defined XML configuration file and a second application that retrieves data aperiodically in accordance with the second set of options specified in the user-defined XML configuration file. The retrieved data is displayed in accordance with the set of display options specified in the user-defined XML configuration file.

### BACKGROUND

The disclosed subject matter relates to data retrieval, and more specifically to a system and methods for displaying data retrieved from data sources on a web portal. In particular, the disclosed subject matter relates to a portal with one or more portlets that are designed to display information from diverse data sources. Retrieved data is typically presented in web pages or web-based graphical user interfaces.

Services relating to data retrieval can be implemented as software components that provide content and/or functionality to remote web applications through the Internet. Remote applications can submit requests for information to web services and receive content in return. Similarly, applications can pass queries to web services by deploying configuration files that contain information regarding the data source, various search filters and display options. A result is returned from the web service to the application based on the queries. Web service content can be passed to a client of the application where it can be displayed, processed, or otherwise utilized.

### SUMMARY

Various applications for retrieving data from data sources and displaying the retrieved data on user or client terminals are well known. However, each application can retrieve only a specific type of data or data from a specific data source. Further, such applications also need to be present locally on a user or a client terminal.

Some related arts access data from multiple data sources and store the retrieved data in a data warehouse. The data stored on the data warehouse is then displayed on the client or user terminals. However, the data stored in the data warehouse may be in a raw format and further formatting of the data is required before the data can be displayed. Further, data retrieval processes are generally implemented by an application server. An application server can be any software framework that facilitates the creation of web applications and a server environment to run them. It behaves as a virtual machine to run applications. Moreover, the application server handles connections to data sources on one end and connections to the client terminal or user terminal through a web client or web portal on the other end. However, using only an application server or a cluster of application servers can limit the dynamic delivery of information. Additional processing functions need to be performed by an end-user or client to obtain information in a customized format. Further, complex client applications may be required to process the data retrieved.

Some related arts use applications present on user terminals to format and display retrieved data. Some other related arts use applications present on user terminals to retrieve and display data periodically. Examples of periodic data retrieval may include retrieval of weather forecasts, stock market news updates, sports news updates and the like. Yet other related arts use applications to retrieve and display data aperiodically based on one or more events. However, such applications format the retrieved data based on predetermined algorithms without providing any option to a user to control the presentation of the retrieved data. Further, such applications may not retrieve data periodically and/or aperiodically at the same instance.

It may therefore be beneficial to provide systems and methods to retrieve data from one or more data sources and display the data periodically in accordance with user-defined display options and data retrieval filters. Specifically, it may be beneficial to generate one or more portlets to facilitate periodic retrieval of data in a legible format. One or more portlets are generated by a portal server to facilitate a single point of access to data retrieved from data sources for end-users or clients.

It may also be beneficial to provide systems and methods to retrieve data from one or more data sources and display the data aperiodically in accordance with user-defined display options and data retrieval filters. Specifically, it may be beneficial to generate one or more portlets to facilitate aperiodic retrieval of data in a legible format.

It may also be beneficial to provide systems and methods to retrieve data periodically and/or aperiodically from multiple data sources and store the retrieved data in a database in a predetermined format. The stored data is displayed on a display interface of a user terminal in accordance with user-defined display options and data retrieval filters.

It may further be beneficial to provide a specification-compliant, end-user-configurable portlet that allows a user to quickly access and return database data using a portal server and present it in a useful format, without programming. Using a web-interface designed for a non-technical end-user, a series of data-presentation options may be selected or configured and saved to an XML (Extensible Markup Language) configuration file. A portal server, with the portlet installed, may be used to present a view of the data as per the configuration options stored in the XML configuration file. Examples of available configuration options include data retrieval filters, data export formats (XML format, Comma Separated Values or CSV format), and various levels of summary and detail.

It may also be beneficial to provide methods enabling a user to create one or more configuration files which dictate certain display options. For example, each configuration file can correspond to a specific user's desired data feeds and/or display options

It may also be beneficial to provide systems and methods that enable a user to create one or more XML configuration files which dictate certain data retrieval filters pertaining to the data retrieval being periodic and/or aperiodic. For example, a user may provide a first query for periodic data retrieval and a second query for aperiodic data retrieval, each of the queries corresponding to a different XML configuration file. In other examples, the user may provide retrieval filters pertaining to both periodic data retrieval and aperiodic retrieval in a single query, the query corresponding to a single XML configuration file.

Some embodiments are directed to systems and methods that facilitate periodic and aperiodic exchange of data between a user terminal and one or more data sources, using one or more portlets installed on a portal server.

Some embodiments are directed to a method for exchanging data between a user and a data source, the method includes configuring a non-transitory computer readable medium to access data from a data source via a data source query in accordance with options specified in a user-defined XML configuration file, the user-defined XML configuration file further specifying a set of display options, a set of data retrieval filters, a first set of options for periodic data retrieval and a second set of options for aperiodic data retrieval. The method further includes retrieving data from the data source in accordance with the data retrieval filters, the first set of options for periodic data retrieval and the second options of aperiodic data retrieval. The retrieved data is displayed in accordance with the set of display options specified in the user-defined XML configuration file. Further, the non-transitory computer readable medium utilizes a first application that retrieves data periodically in accordance with the first set of options specified in the user-defined XML configuration file and a second application that retrieves data aperiodically in accordance with the second set of options specified in the user-defined XML configuration file.

Some other methods are directed to a method of retrieving data from a data source. The method includes receiving a set of display options, data retrieval filters, a first set of options for periodic data retrieval and a second set of options for aperiodic data retrieval from a user via a user interface. The method also includes embedding the data retrieval filters, the set of display options, the first set of options and the second set of options in a user-defined XML configuration file. The method further includes retrieving data from the data source in accordance with the data retrieval filters, the first set of options and the second set of options embedded in the user-defined XML configuration file. The method further includes storing data in a database in accordance with a predefined format; and generating one or more portlets to display data to the user in accordance with the set of display options, the first set of options, the second set of options and the predefined format.

Yet other embodiments are directed to a system for exchanging data between a user and a data source, the system including a web portal that is configured to receive a data source query from the user, the data source query corresponding to the data source. The system further includes a processor that is configured to generate a user-defined XML configuration file based on the data source query, the user-defined XML configuration file including a set of display options, data retrieval filters, a first set of options for periodic data retrieval and a second set of options for aperiodic data retrieval. The system further includes a portal server communicably coupled to the web portal, the portal server configured to retrieve data from data source in accordance with data retrieval filters, the first set of options and the second set of options specified in the user-defined XML configuration file, and store data in a database in accordance with a predefined format. The portal server is further configured to generate one or more portlets to display data by the web portal in accordance with the set of display options, the first set of options, the second set of options and the predefined format.

As mentioned above, the disclosed systems and methods address a problem occurring in related art processing devices that utilize data portlets, in that there is often an inability to communicate with multiple data sources simultaneously and cohesively populate a database, a graphical user interface (GUI) display, or to perform any form of reliable real-time data analytics with information from disparate sources that may preferentially release data periodically or aperiodically. For example, a social media feed might release information nearly instantaneously when a user enters information, whereas a different source of information (such as the global database of events, language and tone (GDELT), weather services, media outlets, etc.) may only release information at fixed intervals. This can present difficulty in coordinating and prioritizing the data points received by software designed to interpret trends, analyze and coordinate numerous data feeds, and predict financial, global, or even individually targeted trending data.

Some of the disclosed embodiments address this problem by coordinating a combination of periodic and aperiodic data retrieval schemes from varying data sources. In some embodiments, the data sources can be prioritized or scored using software evaluating the relevance, veracity, and immediacy of a topic that can be ascertained based on key words, time of receipt, or applicability to a particular trend of interest. A software application correlating information could then be configured to weight events that are occurring aperiodically in real time (e.g., a foreign conflict) with data sets that are only periodically provided (e.g., weather forecasts), creating an estimate of current regional safety, financial trends, or any other topic of interest.

In such a situation, a processor may weigh the periodic data more heavily, as the likelihood of combat (aperiodic data) during a monsoon (periodic weather data) may be lower, and hence not of immediate concern. Alternatively, a barrage of information from an aperiodic data source (such as a sudden flood of information containing key words relating to elections, stock-market swings or terrorism) may supersede environmental or other domestic conditions in prediction of an imminent regional threat. In either situation, it would be beneficial for a processor running software to perform a sophisticated analysis of both periodically and aperiodically distributed information in a routine that attempts to balance each and make reasonably informed decisions in accordance with all of the information available.

### BRIEF DESCRIPTION OF DRAWINGS

The foregoing and other aspects of the embodiments disclosed herein are best understood from the following detailed description when read in connection with the accompanying drawings. For the purpose of illustrating the embodiments disclosed herein, there is shown in the drawings embodiments that are presently preferred, it being understood, however, that the embodiments disclosed herein are not limited to the specific instrumentalities disclosed. Included in the drawings are the following figures:

FIGS. 1A, 1B and 1C illustrate various exemplary systems for retrieving and displaying data in accordance with the disclosed subject matter.

FIG. 2 illustrates a Data Integration Portlet in accordance with the disclosed subject matter.

FIG. 3 is a schematic of a user interface shown on a portal page in accordance with the disclosed subject matter.

FIG. 4 is a flowchart of an exemplary method for retrieving data in accordance with the disclosed subject matter.

FIG. 5 is a flowchart of an exemplary method for retrieving data in accordance with the disclosed subject matter.

FIG. 6 is a Service Integration Module (SIM) Portlet for retrieving and displaying data in accordance with the disclosed subject matter.

FIG. 7 is a computer system that can be used to implement various exemplary embodiments of the disclosed subject matter.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill .in the art will recognize a number of equivalent variations of the various features provided in the description that follows.

### I. Server Environment

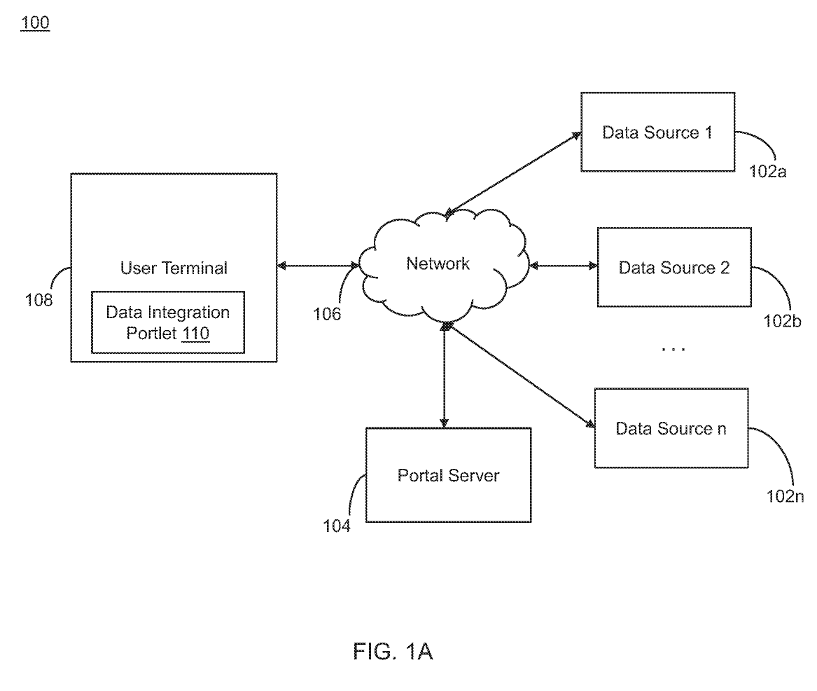

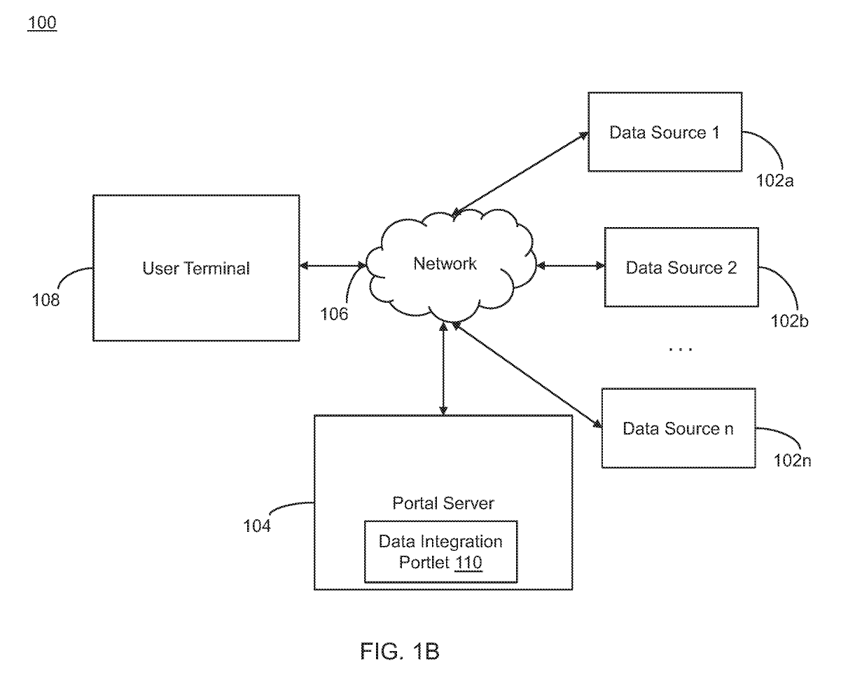

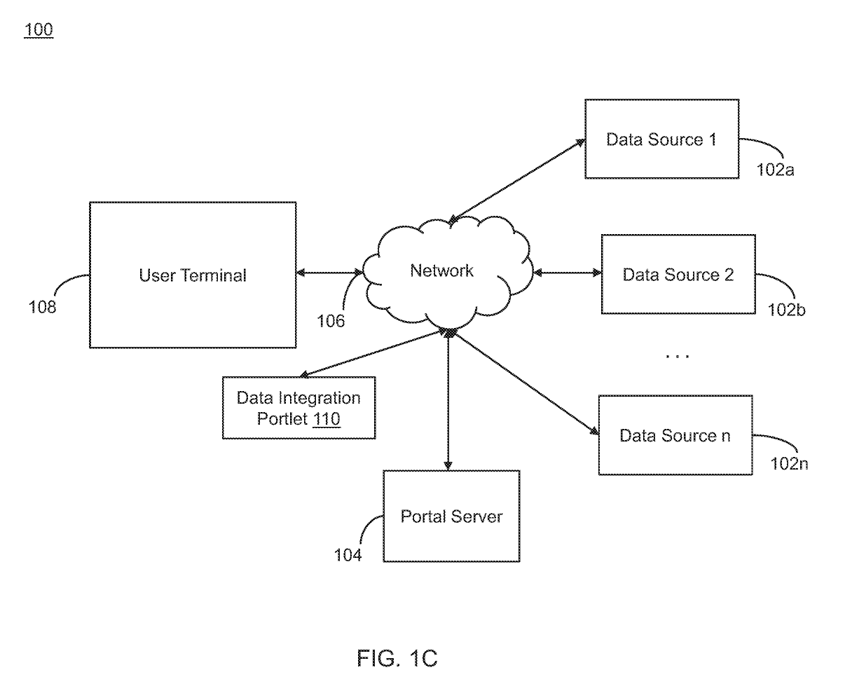

FIG. 1A is an illustration of a system 100 in accordance with the disclosed subject matter. The system 100 is configured to retrieve and display data. Specifically, the system 100 facilitates exchange of data between a user terminal 108 (hereinafter referred to as “the user 108”) and one or more data sources 102 through one or more portlets installed on a portal server 104. In some instances, the portal server 104 may be positioned in series with the user terminal, or may even be configured as a part of the user terminal itself (such as an app, Operating System routine, or the like). The data to be exchanged is retrieved in accordance with an Extensible Markup Language (XML) configuration file that may contain various forms of information. This information can include, but is not limited to, connection information, display preference information, and user query information. The XML file can also include data retrieval filters, keywords, metadata or metadata tracking information and so forth.

In some embodiments, the user 108 can provide a query to retrieve periodic data from the data sources. Periodic data retrieval pertains to data being retrieved at finite intervals of time. For example, a query provided by an end-user regarding the topic “French food” may include a data retrieval filter specifying periodic data retrieval. Accordingly, information regarding “French food” is retrieved and displayed to the end-user at the end of a specified finite interval.

In some other embodiments, the user 108 can provide a query to retrieve data from a data source in response to an event trigger. For example, data from a social network can be retrieved and displayed to an end-user if the data relates to the event trigger in the context of a set of keywords, timestamp, a geographic location, and so forth. Further, data can be displayed to the end-user if a new event entry (for example, a new blog entry or a social media post) is identified. The data can be retrieved at any time so long as an event trigger is identified.

The data sources 102a to 102n (hereinafter collectively termed as “the data sources 102:) are intended to be any type of data source including social media networks, search engines, portals, remote servers, network storage units etc. Embodiments are also intended to include or otherwise cover any other type of data source. The data sources 102 are merely provided for exemplary purposes, and the various inventive aspects are intended to be applied to any type of data source on a network 106 connected to the portal server 104 and the user 108.

The network 106 may include a data network such as, but not restricted to, the Internet, local area network (LAN), wide area network (WAN), metropolitan area network (MAN) etc. In certain embodiments, the communication network 106 can include a wireless network, such as, but not restricted to, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS) etc. In some embodiments, the communication network 106 may include or otherwise cover networks or subnetworks, each of which may include, for example, a wired or wireless data pathway. The communication network 106 may include a circuit-switched voice network, a packet-switched data network, or any other network capable for carrying electronic communications. For example, the network may include networks based on the Internet protocol (IP) or asynchronous transfer mode (ATM), and may support voice usage, for example, VoIP, Voice-over-ATM, or other comparable protocols used for voice data communications. In one implementation, the network includes a cellular telephone network configured to enable exchange of text or SMS messages.

Examples of the network 106 may further include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth. Embodiments are intended to include or otherwise cover any type of network, including known, related art, and/or later developed technologies to connect the data sources 102, the portal server 104 and the user 108 with each other.

The user 108 is intended to include any electronic device, such as desktop computers, portable computers, smartphones, tablet computers, wearable devices, and the like. The user 108 may also include a display unit (not shown) for displaying any data. The display unit can include, but not limited to, a Cathode Ray Tube (CRT) display, a Liquid Crystal Display (LCD), a Light Emitting Diode (LED) display, and the like. Embodiments are intended to include or otherwise cover any type of display, including known, related art, and/or later developed technologies.

The portal server 104 generates a Data Interchange Portlet 110 (hereinafter referred to as “the DIP 110”) that is a specification-compliant, end-user-configurable portlet that allows a user 108 to quickly access and return database data using a portal server and present it in a useful format, without programming beyond the generation of the XML configuration file. In some embodiments, the DIP 110 may be part of the user 108, as seen in FIG. 1A. In some other embodiments, the DIP 110 may be part of the portal server 104 (as shown in FIG. 1B) or may be placed next to the user 108 (as shown in FIG. 1C).

Through a web-interface designed for a non-technical end-user, a series of data-presentation options may be selected (configured) and saved into an XML (Extensible Markup Language) configuration file. The XML configuration file can also be manually configured. For example, the XML configuration file may be configured in a word processing application. The portal server 104, with the DIP 110 installed, is used to present a view of the data as per the configuration options stored in the XML configuration file. Examples of available configuration options include data retrieval filters, data export formats (XML format, csv format), and various levels of summary and detail. The XML configuration file may further include artistic guidelines, such as displaying a three-day weather forecast in the top-left corner of a portal page, and news in the bottom-right corner the portal page. The XML file may also be arbitrarily specific, such as weather in Seattle being displayed in the top left of the portal page, while arrest reports from anyone in Miami named “Edward” being displayed in the bottom right corner of the portal page.

In some embodiments, a processor (not shown) associated with the user 108 may generate the XML configuration file and store it on a memory (not shown) associated with the user 108. Further, the portal server 104 may be communicably coupled to the user 108 in order to access the configuration options stored in the XML configuration file. In other embodiments, the processor that generates the XML configuration file may be associated with the portal server 104.

The portal can be a web portal or an enterprise portal and is configured to aggregate data from different sources and display the aggregated data. In an embodiment, the portal is a web page that brings information together from diverse sources. Each piece of information from a specific source may be provided with a dedicated display or presentation area on the portal as defined by an end-user or web designer. The dedicated display or presentation area is handled or managed by one or more portlets. Portlets are applications used by a data portal website to receive requests from a client terminal or a user terminal and return information. In some embodiments, the portal server 104 is the middleware between an application server (not shown) and the user 108. The portal server 104 can run on top of the application server or a cluster of application servers. The application server or the cluster of application servers can host web applications related to data retrieval.

### II. Portals and the Data Integration Portlet

A web portal is a specially designed web site that brings information together from diverse sources in a uniform way. Usually, each information source gets its dedicated area on the page for displaying information (a portlet). Optionally, the end-user can configure which of the portlets to display. Variants of portals include mashups and intranet “dashboards” for executives and managers. The extent to which content is displayed may depend on the intended end-user and the intended purpose, as well as the diversity of the content. Very often design emphasis is on a certain “metaphor” for configuring and customizing the presentation of the content and the chosen implementation framework and/or code libraries. In addition, the role of the end-user in an organization may determine which content can be added to the portal or deleted from the portal configuration.

A portal may use a search engine application program interface (API) to permit end-users to search intranet content as opposed to extranet content by restricting which domains may be searched. Apart from this common search engines feature, web portals may offer other services such as e-mail, news, stock quotes, information from databases and even entertainment content. Portals provide a way for enterprises and organizations to provide a consistent look and feel with access control and procedures for multiple applications and databases, which otherwise would have been different web entities at various uniform resource locators (URL). The features available may be restricted by whether access is by an authorized and authenticated end-user (employee member) or an anonymous site visitor.

Portal servers provide a central platform for accessing web content and resources (data, docs, apps, integrations, alerts, etc.). A core feature of a portal is to provide a central URL that permits an end-user to have a custom web experience based upon the end-users' login identity. This functionality is termed role-based content delivery, or RBCD, and is a main focus for portals.

Websites based on Role-based Content Delivery (RBCD) allow an enterprise to develop a central web platform. Enterprises can then advertise a single website, and thereby increase the usage of the entire enterprise's resources as the central portal can integrate or guide end-users to other resources. RBCD modules allow administrators to build portal pages for different end-user types to customize the end-user experience based on an end-user's “formal identity,” such as a salesperson, engineer or manager.

Given that portal pages can include both applications (portlets and widgets) and web content, many related arts disclose portals supporting integration to an external web content management system (WCMS) allowing content to be created or managed in a WCMS that appears in a portal page. This two-step process of adding content prompted some other portals to create an embedded WCMS.

Some related arts disclose allowing end-users to interact with the system. End-users are often allowed to create their own pages or sites, to add collaboration apps to those pages and to define end-user access to those pages. Many portals also enable power end-users to have added features, such as web forms, workflows, dynamic lists and polls.

This focus on enabling the end-user, combined with RBCD, allows a central site to enable both the formal organizational structure as well as the informal organizational structure (a.k.a., social collaboration) and is a major difference between portals and many WCMS systems.

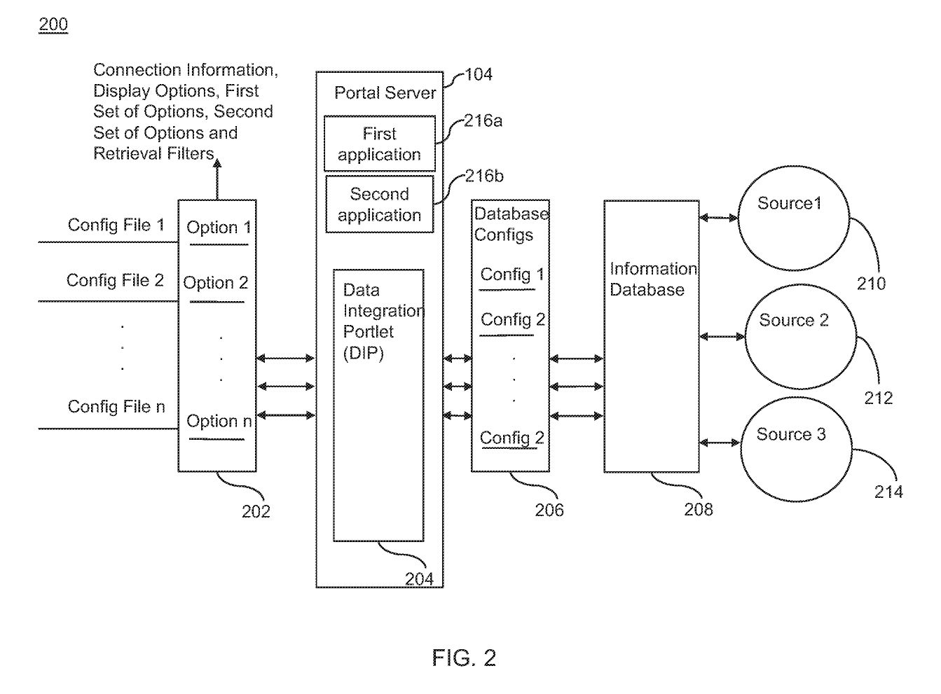

FIG. 2 illustrates an exemplary system 200 including a Data Integration Portlet (DIP) 204, installed and placed on the portal server 104, in conjunction with the user 108, the data source 210, the data source 212 and the data source 214. As illustrated in FIG. 2, the user 108 can create one or more configuration files (1-N as labeled in FIG. 2) which can dictate certain display options. For example, each configuration file can correspond to a specific user's desired data feeds and/or display options 202 (e.g., configuration file 1 for John, configuration file 2 for Heather, and so forth). Alternatively, configuration files can correspond to different topics of interest, such as weather forecasts around a country (configuration file 1), political news (configuration file 2), etc. The configuration files can also set the display options that can ultimately appear in the portal page.

The portal server 104 further includes a first application 216a and a second application 216b that are configured to retrieve periodic data and aperiodic data, respectively, from the data source 210, the data source 212 and/or the data source 214. Further, in some embodiments, the first application 216a and the second application 216b can also be installed on the application server (not shown), the portal server 104 or on the user terminal 108.

The user 108 can create data source queries based on the data to be retrieved. Each data source query can create one or more configuration files. The data source queries include, but are not limited to, data retrieval filters, display options, a first set of options for periodic data retrieval, and/or a second set of options for aperiodic data retrieval. The first set of options can include, but not limited to, a checkbox for selecting periodic data retrieval, option for selecting time period for periodic retrieval of data, and the like. The second set of options can include, but not restricted to, a checkbox for selecting aperiodic data retrieval, option for selecting an event trigger for aperiodic retrieval of data, and the like. The data source query can also include one or more identities indicative of data source and one or more sets of keywords. Specifically, the data source query can correspond to one or more of the data sources 210, 212 and 214, and can include one or more identities indicative of the corresponding data source(s).

The configuration files, that are based on the data source queries, can therefore include the data retrieval filters, the display options, the first set of options for periodic data retrieval and the second set of options for aperiodic data retrieval. The configuration files can also include connection information corresponding to the data sources 210, 212 and/or 214. Connection information includes, but is not limited to, IP addresses, subnet masks, domain name server addresses, host name and suffix, execution parameters, system information pertaining to the user 108 and/or the portal server 104. The display options include, but are not limited to, at least one of a tabular layout, a chart layout, a news layout, a form layout, and a bullet layout. The data retrieval filters include one or more identities indicative of a data source as the data source 210, the data source 212 and/or the data source 214.

The portal server 104 includes a non-transitory computer readable medium that can be configured to access data from the data source 210, the data source 212 and/or the data source 214. In other embodiments, the portal server 104 includes a non-transitory computer readable medium that is configured to access data from multiple data sources not limited to the data source 210, data source 212 and/or data source 214. The non-transitory computer readable medium may be a set of instructions executable by the portal server 104 to carry out various operations including, but not limited to, accessing and retrieving data, storing data, generating portlets and displaying data through the portlets. In some embodiments, the non-transitory computer readable medium can be configured by the portal server 104 to carry out various operations. Further, configuring the non-transitory computer readable medium may include executing the instructions stored therein.

In some embodiments, the Data Integration Portlet (DIP) 204 can be installed in the portal server 104. One or more XML configuration files provide connection information, user-defined display options and data retrieval filters to the portal server 104 using the DIP 204. In some embodiments, the connection information, the user-defined display options and the data retrieval filters form a user-defined data source query having a corresponding XML configuration file.

Further, each XML configuration file is extracted to a configuration file database 206. The portal server 104 can utilize a single query defined by the user 108 to extract data from multiple tables within an information database 208. In some embodiments, the information database 208 may be a relational database and/or an object-relational database. The information database 208 organizes data into one or more tables of columns and rows with a key identifying a row and/or column in each table. The keys for each row and/or column are used to define logical connections (called relationships) among the tables. Based on the user-defined data source queries, the data residing in the tables are retrieved such that the data can be presented at the user 108 in a legible format. The data stored in multiple tables on the information database 208 is retrieved from any or a combination of the data source 210, the data source 212 and the data source 214. In some embodiments, the portal server 104 may retrieve data from the data sources 210, 212 and/or the 214 in real time as per the user query received at the portal server 104. In some other embodiments, the portal server 104 may store data in the information database 208 prior to receipt of the user query at the portal server 104.

Further, data extracted by the portal server 104 is stored in the information database 208 in a predefined format. The predefined format corresponds to the data being organized in multiple tables with a key identifying a row and/or column in each table in the data. Logical connections are provided between the rows and columns of one table and the rows and columns of another table.

The portal server 104 can transform the data retrieved from the data source 210, the data source 212 and/or the data source 214 in accordance with the predefined format and populate the tables of the information database 208 with the data retrieved from the data sources 210, 212 and/or 214. The portal server 104 can implement various algorithms to convert or transform the retrieved data including, but not limited to, including statistical methods, probabilistic methods, and so forth. In case, any data does not include an entry corresponding to any of the tables, the tables are left blank. Therefore, the information database 208 may allow standardization of data from different data sources, and enable quick display of the stored data in accordance with the predefined format, and the first and/or second set of options.

In some embodiments, the configuration file database 206 may be a relational database that contains the user-defined data source queries retrieved from the XML configuration files. The data retrieval filters, the first set of options, the second set of options and the display options are stored in one or more tables with a key identifying a row and/or column in each table. The keys are used to define logical connections or relationships among the tables.

The portal server 104 includes a set of software applications that enables generation of portals. The portal server 104 further acts as a single access point for the user 108 to retrieve data from the data source 210, the data source 212 and/or the data source 214.

In an embodiment, the user queries, the display options, the first set of options, the second set of options and the data retrieval filters may be obtained via a user interface which will be described in detail hereinafter.

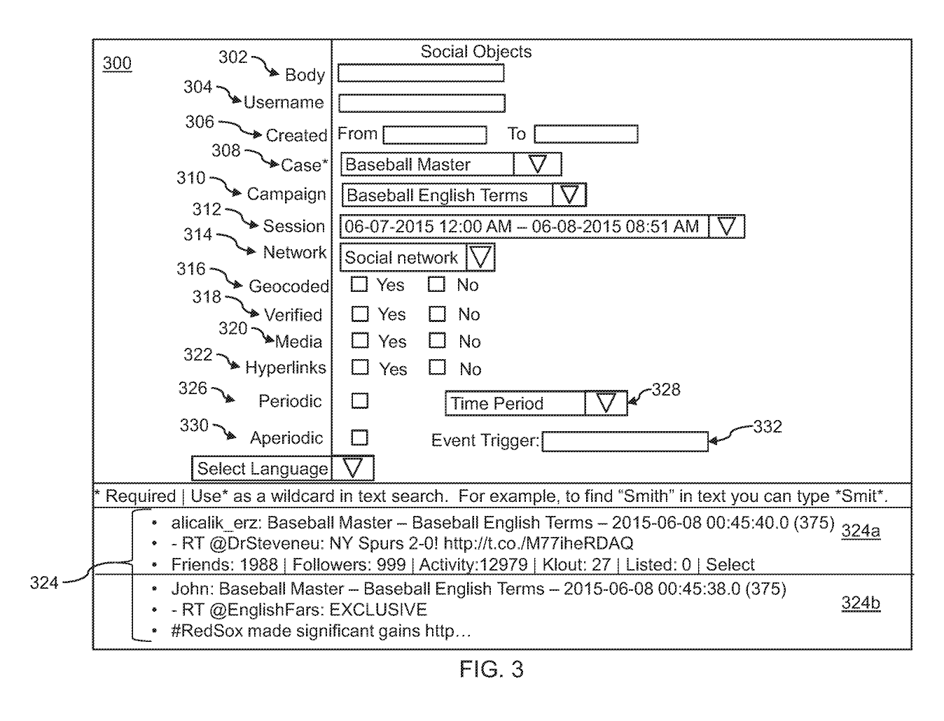

FIG. 3 illustrates an exemplary embodiment of a user interface 300 presented on the user 108. The user interface 300 includes fields for various query parameters. The fields include, but are not limited to, a body field 302, a username field 304, a query creation dates field 306, a query title or case field 308, a language of retrieved data field 310, date/time stamp details field 312, a data source field 314, location filters field 316, authenticate filters field 318, a selection field 320 for the retrieval of images, hyperlinks filters field 322 for audio/video options, a periodic data retrieval field 326, a time period field 328 for periodic data, an aperiodic data retrieval field 330 and an aperiodic data event trigger field 332.

The periodic data retrieval field 326 may include a checkbox to enable the end-user to select periodic data retrieval of data. If the end-user selects the periodic data retrieval field 326, a first parameter or a flag indicative of periodic data retrieval may be included in the user data source query and the corresponding XML configuration file. Similarly, the aperiodic data retrieval filed 330 may include a checkbox to enable the end-user to select aperiodic data retrieval of data. If the end-user selects the aperiodic data retrieval field 330, a second parameter or a flag indicative of aperiodic data retrieval may be included in the user data source query and the corresponding XML configuration file.

The portal sever 104 may determine that the data source query includes the first parameter indicative of periodic data retrieval and selects a default time period. Further, the time period field 328 may include a drop down menu for multiple time periods that can be chosen by the end-user. If the end-user does not select a time period, the portal server 104 may use the default time period for periodic data retrieval. The portal server 104 may accordingly generate the first set of options that includes the first parameter and the user-defined time period or the default time period. The time period may be in various magnitudes, including seconds, minutes, hours, days, and so forth. In some embodiments, the portal server 104 may generate the first set of options including the default time period upon determining that the data source query includes the first parameter. In case, the end-user selects a time period, the portal server 104 may modify the first set of options to include the user-defined time period.

The portal sever 104 may determine that the data source query includes the second parameter indicative of aperiodic data retrieval. Further, the aperiodic data event trigger field 332 may enable the end-user to enter an event trigger required for aperiodic data retrieval. If the end-user fails to provide an event trigger, the portal server 104 may set the event trigger as a new event or entry at the corresponding data source. The portal server 104 may accordingly generate the second set of options that includes the second parameter and the event trigger.

Results are displayed according to choices made in the aforementioned fields at a results field 324. In some embodiments, the results field 324 is associated with one or more portlets. Each of the fields 302 to 322, fields 326 to 332 and the results field 324 correspond to one or more portlets generated by the portal server 104. Further, the results are displayed through a first portlet 324a and a second portlet 324b. The first portlet 324a and the second portlet 324b may be generated by the portal server 104. In some embodiments, the first portlet 324a may include data retrieved periodically, while the second portlet 324b may include data retrieved aperiodically.

In some embodiments, the first application 216a may extract the first set of options from the XML configuration file, and retrieve data periodically based on the time period embedded in the XML configuration file. The first application 216a may further generate the first portlet 324 to display the periodically retrieved data. The first application 216a may also periodically refresh the first portlet 324a

In other embodiments, the second application 216b may extract the second set of options from the XML configuration file, and retrieve data aperiodically based on the event trigger embedded in the XML configuration file. The second application 216b may further generate the second portlet 324b to display the aperiodically retrieved data.

Choices made on the user interface 300 form the user data source query and is embedded into the Extensible Markup language (XML) configuration file stored on the user 108. An example of the information stored in the XML configuration file is shown below:

```
<QuerySettings>
  <DatabaseVendor>PostgreSQL</DatabaseVendor>
  <Connection>
    <ConnectionID>2</ConnectionID>
  </Connection>
  <QueryString>SELECT verifiedimg, verifiedyn, username, displayname,
authorkloutscore, useractivitycount, friends,
followers, listedcount, favoritescount, retweetcount,
generator, verified, profileimgurl, network, created, createdyear,
createdmonth, createdday, body, isre, origobjsrcid, objectsrcunid,
origauthor, sourceid, hashtags,
languages, expandedurls, verb, usermentionsnames, usermentionsids,
mediaurls, lon, lat, headline,
tagline, createdby, objectcreateddate, geocoordinates,
linktoobject, resultid, Geocoded, globe, resultid, id, userbiolocation,
mediatype, usermentionsscreennames, actorid, verified, userbiolocation,
sentiment_tag, sentiment_score, user_sentiment_votes,
user_sentiment_average, user_sentiment_mode, user_sentiment_median,
mediayn, tsv_body
```

The above is a snippet from an exemplary XML configuration file used in accordance with the disclosed subject matter. Each XML configuration file uses a single query extracted from the input through the user interface 300 to retrieve data from multiple tables within the information database 208.

The XML configuration file is used for the processing, definition and presentation of data on the user interface 300. Through the XML configuration file, code is specified for formatting various layouts and styles pertaining to presentation of data. The XML configuration file, as seen in the sample code above, includes the user-defined query, that further includes communication information, the display options, the data retrieval filters, the first set of options and the second set of options. The XML configuration file also provides connection information to enable a connection between the user 108 and the information database 208 (in the current example the information database 208 being an object-relational database provided by PostgreSQL®). The multiple fields 302 to 322, and 326 to 332 may be populated by an end-user. Based on the information provided through the fields 302 to 322, and 326 to 332 various display options and data retrieval filters, such as the tags provided in the XML code above, are enabled and form a user-defined data source query. The XML configuration file further acts as a tool to transport the user-defined query information from the user 108 to the configuration file database 206 and the information database 208. Subsequently, based on the user-defined query, the portal server 104 extracts the data corresponding to the retrieval filters specified at the fields 316 to 322, and 326 to 332 from the data source specified at the field 314. The data is extracted and stored in a predefined format at the information database 208. Subsequently, the extracted data is presented based on the display options specified in the user-defined query through the portlets corresponding to the results field 324 as shown in FIG. 3.

In order for a single query, such as that shown in the XML sample above, to retrieve data from multiple sources, the data would need to exist in any of the data source 210, the data source 212 and/or the data source 214 and in the information database 208 specified in the query.

The database connection details or connection information, such as that referenced in the XML code above, can be specified in the same XML configuration file or a separate XML configuration file.

### III. Exemplary Embodiments

In an exemplary embodiment according to the disclosed subject matter, a first XML configuration file is generated at the user 108 with a first data source query embedded therein. The data source query includes connection information, data retrieval filters, a first set of options for periodic data retrieval, a second set of options for aperiodic data retrieval and display options. As shown in FIG. 3, the fields 302 to 322 and the fields 326 to 332 in the user interface 300 are populated such that user-defined options relating to data retrieval filters and display options are specified. The user interface 300 is displayed on a display interface (not shown) that is included with the user 108. In accordance with the sample XML code above, the populated fields 302 to 322 and 326 to 332 enable selections of the query strings such that the user query is created and embedded into the XML configuration file.

In some embodiments the end-user may enable periodic data retrieval by checking the periodic data retrieval field 326 and define a time period at the time period field 328, thereby providing the first set of options in the data source query. Further, in some other embodiments, the end-user may enable aperiodic data retrieval by checking the aperiodic data retrieval field 330. Using the DIP 204 in conjunction with the first and second applications 216a and 216b that are installed on the portal server 104, the data source query along with other configuration information contained in the XML configuration file is transmitted to the configuration file database 206.

The information database 208, as shown in FIG. 2, stores data retrieved from the data source 210, the data source 212 and/or the data source 214. The data may be retrieved prior to the user-defined query being received at the configuration file database 206. In some embodiments, the data may be retrieved upon receiving the user query. The retrieved data is stored on the information database 208 in a predefined format. The predefined format includes the retrieved data being stored in multiple tables with each row and/or column of each table being identified by a key. The keys are used to establish logical connections between rows and columns of one table with the rows and columns of another table in the information database 208. Based on the user-defined query stored in the tables of the configuration file database 206, a set of retrieved data, corresponding to one or more of the data source 210, the data source 212 and the data source 214, is extracted from the tables of the information database 208 and presented on the user interface 300 (as shown in FIG. 3) at the portlets corresponding to the results field 324.

If the end-user opts for periodic data retrieval, data is extracted periodically, via the portal server 104 in conjunction with the first application 216a, from the information database 208 and presented on the user interface 300. The data is further displayed periodically at the corresponding portlets in the results field 324 as per the first set of options including the user-defined or default time period.

If the end-user opts for aperiodic data retrieval, data is extracted aperiodically, via the portal server 104 in conjunction with the second application 216b, from the information database 208 and presented on the user interface 300. Further, data is retrieved aperiodically in accordance with the second set of options including the event trigger.

The retrieved data can be displayed on one or more portlets 324a and 324b in the results field 324. For example, if the end-user provides a query for posts about food to be displayed at the user 108 and sets the event trigger as “Italian food” then the user 108 can receive data regarding posts about food on one or more of the portlets 324a and 324b. The user 108 can also receive data in case there is any new entry regarding “Italian food”. Therefore, the portal server 104 in conjunction with the applications 216a and 216b can enable both periodic and aperiodic data retrieval and display based on a single data source query.

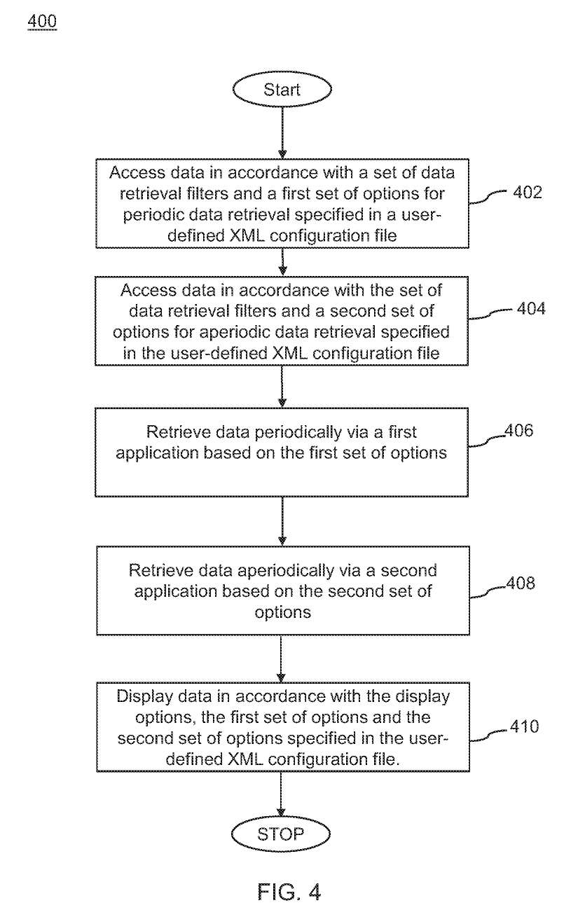

FIG. 4 illustrates a method 400 of exchanging data between the user 108 and any one or a combination of the data source 210, the data source 212 and the data source 214 in accordance with the disclosed subject matter. This flowchart is merely provided for exemplary purposes, and embodiments are intended to include or otherwise cover any methods or procedures for data retrieval.

At step 402, a non-transitory computer readable medium is configured to access data from the data source via a data source query in accordance with a set of data retrieval filters and a first set of options for periodic data retrieval specified in a user-defined XML configuration file. At step 404, the non-transitory computer readable medium is medium is configured to access data from the data source via the data source query in accordance with the set of data retrieval filters and a second set of options for aperiodic data retrieval specified in the user-defined XML configuration file. In some embodiments, a processor (not shown) associated with the user 108 generates the user-defined XML configuration file and stores it on a memory (not shown) associated with the user 108. The portal server 104 includes the non-transitory computer readable medium, the first application 216a and the second application 216b. The data source may be selected through choices on the user interface 300 and the choices are embedded into the user-defined XML configuration file stored on the user 108. Further, the set of display options, the set of data retrieval filters, the first set of options and the second set of options are provided at the populated fields 302 to 322 and 326 to 332 on the form-based user interface 300.

In some embodiments, the end-user may enable periodic data retrieval by checking the periodic data retrieval field 326 and define a time period at the time period field 328, thereby providing the first set of options in the data source query. Further, in some other embodiments, the end-user may enable aperiodic data retrieval by checking the aperiodic data retrieval field 330. Using the DIP 204 in conjunction with the first and second applications 216a, 216b that are installed on the portal server 104, the data source query along with other configuration information contained in the XML configuration file is transmitted to the configuration file database 206.

At step 406, data is retrieved periodically, via the portal server 104 in conjunction with the first application 216a, based on the first set of options from the data source. The end-user sets a time period for the periodic data retrieval at the time period field 328. Further, the portal server 104 in conjunction with the first application 216a determines whether data source query includes parameters indicative of periodic data retrieval. In the event that a user-defined time period is unavailable, a default time period for the periodic data retrieval is utilized by the application 216a.

At step 408, data is retrieved aperiodically via the portal server 104 in conjunction with the second application 216b based on the second set of options from the data source. The end-user provides an event trigger at the aperiodic data event trigger field 332. Further, the portal server 104 in conjunction with the second application 216b determines whether data source query includes parameters indicative of aperiodic data retrieval. In the event that a user-defined event trigger is unavailable, the portal server 104 in conjunction with the application 216b may set the event trigger as a new event or entry at the corresponding data source.

Further, the user can make changes in the query to retrieve both periodic as well as aperiodic data in accordance with the display options specified in the XML configuration file.

The data retrieved as per steps 406 and 408 is stored in the information database 208 in accordance with a predefined format. The predefined format is a presentation format that is implemented in accordance with the display options made available through the XML configuration file and subsequently the form-based user interface 300. Such a format facilitates data retrieval processes in a customized presentation as defined by the user 108.

At step 410, the portal server 104 displays the requested data using the DIP 204. The data stored at the information database 208 can be extracted in accordance with the display options specified in the user-defined XML configuration file and presented on the user interface 300 through the user 108. The requested data can be displayed on the portlets 324a and 324b.

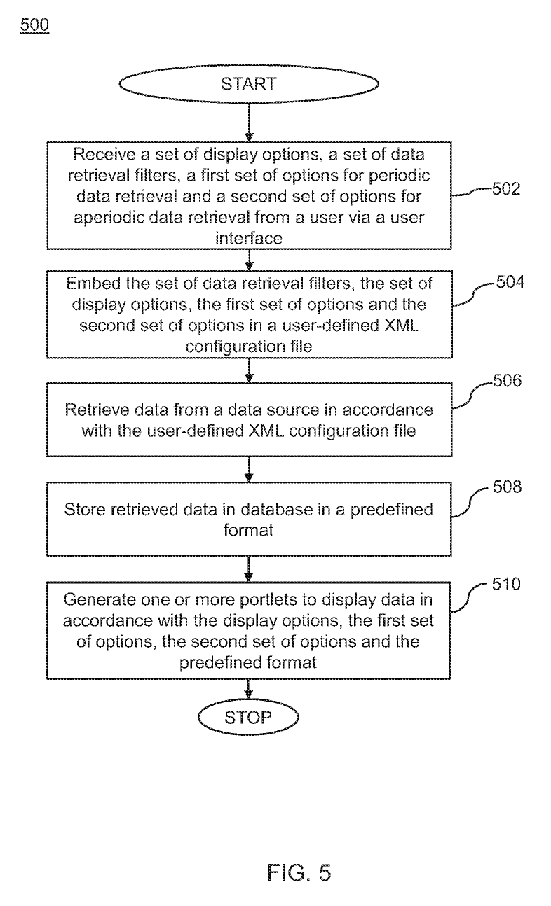

FIG. 5 is a flowchart of a method 500 for retrieving data from one or more data sources in accordance with the disclosed subject matter. Through the form-based user interface 300, a data source query is received at step 502. The data source query can include, but is not limited to, data retrieval filters, a first set of options for periodic data retrieval, a second set of options for aperiodic data retrieval, and/or display options. The data retrieval filters include, but not restricted to, one or more identities indicative of a data source from one or more data sources illustrated in FIG. 2 as the data source 210, the data source 212 and/or the data source 214. The display options can include, but are not limited to, at least one of a tabular layout, a chart layout, a news layout, a form layout, and a bullet layout.

At step 504, the data retrieval filters, the first set of options, the second set of options and the display options are embedded in the XML configuration file. The user-defined XML configuration file further includes connection information which constitute any one or a combination of IP addresses, subnet masks, domain name server addresses, host name and suffix, execution parameters, system information pertaining to the user 108, the first application 216a, the second application 216b and/or the portal server 104. At step 506, a set of data is retrieved from the data source 210, the data source 212 and/or the data source 214. Further, at step 508, the retrieved data is stored in a predefined format in the information database 208. The predefined format includes all of the display options specified in the XML configuration file.

In accordance with the display options embedded in the XML configuration file and the predefined format, at step 510, the first application 216a generates, using the DIP 204, the first portlet 324a to display the data retrieved periodically as per the first set of options. Further, the second application 216b generates, using the DIP 204, the second portlet 324b to display the data retrieved aperiodically as per the second set of options. In some other embodiments, the generated portlets mat lead to a new web page showing the retrieved data.

In some embodiments, the end-user defines a time period for the retrieval of periodic data, for which the first set of options can be generated. Further, the portal server 104 in conjunction with the second application 216b receives an event trigger 332 from the user 108 and generates the second set of options. Accordingly, the first set of options and the second set of options are embedded in the user-defined XML configuration file.

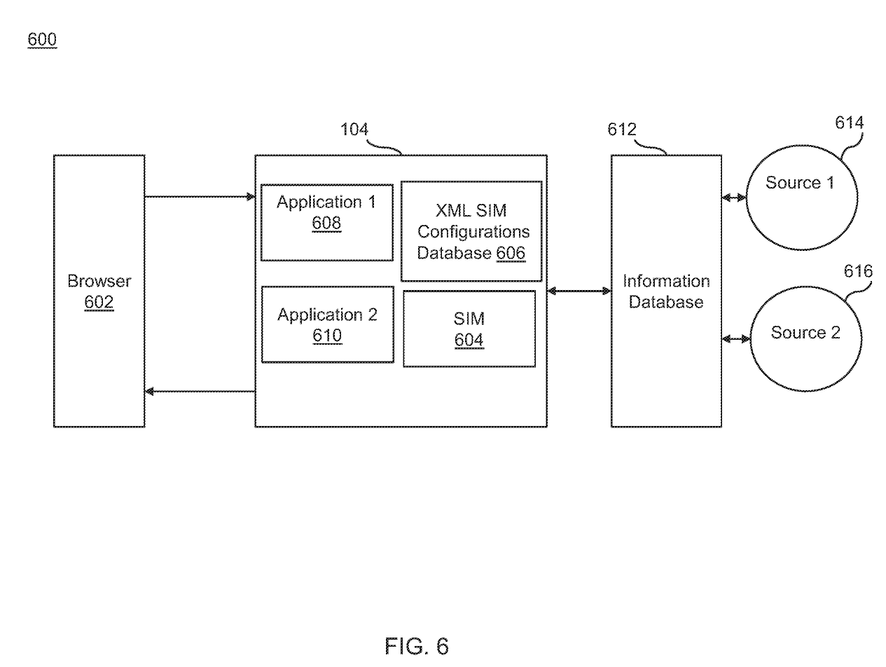

In some alternate embodiments, the portal server 104 may have a Service Integration Module (SIM) portlet installed. FIG. 6 illustrates an exemplary system of a SIM 604.

The SIM 604 is a specification-compliant, end-user-configurable portlet that serves as an intermediary between a portal web-page shown on a browser 602 and data sources 612 and 614, thus allowing a user 108 to transmit a data source query in order to retrieve data from data source 614 and data source 616. In other embodiments, the data may be retrieved from one or more data sources not limited to data sources 614 and 616. The data source query can include, but is not limited to, data retrieval filters, a first set of options for periodic data retrieval and a second set of options for aperiodic data retrieval. The data retrieval filters include, but not restricted to, one or more identities indicative of a data source from one or more data sources illustrated in FIG. 2 as the data source 614 and the data source 616. Where the SIM 608 portlet is included on the portal web page of the browser 602, a “listener” or a series of “listeners” may be selected. When the web-page is loaded by the portal, the selected “listeners” are made available to be called via a JavaScript function call. When called via a JavaScript function call, a listener receives the parameter(s) passed to it, if any, and executes a database query stored in an XML configuration file. The SIM 606 then returns data resulting from the query, if any, to the browser in the format (typically XML or JSON) specified by the user. The user may then format and display that data as desired.

A listener may represent the interface on the portal web page of the browser 602 that is provided with an event trigger for aperiodic data retrieval and/or time periods for periodic data retrieval. In the case of periodic data retrieval, a listener on the portal page is used to notify the portal server 104 of the completion of the time period and retrieve data from the data sources 614 and/or 616. In the case of aperiodic data retrieval, the listener notifies the portal server 104 of an event trigger that triggers the retrieval of data from the data sources 614 and/or 616. For example, a data source query pertaining to “French food” may include periodic and aperiodic data retrieval from a social network. The data source query may include retrieval of data every 24 hours. Additionally, the data source query may also include retrieval of data concerning a celebrated chef posting on the social network. The listeners on the portal page of the browser 602 may be configured to notify the portal server to retrieve data every 24 hours and also to retrieve data whenever the celebrated chef posts data on the social network.

As shown in FIG. 6, the portal server 104, in conjunction with the first application 608 and the second application 610, periodically and/or aperiodically retrieves and displays data at the portal page of the browser 608. Data is retrieved from the data sources 614 and/or 616 and stored on the information database 612. In some embodiments, the data source queries may be extracted to the XML SIM Configurations database 606.

The SIM 604 is capable of retrieving data of any format (particularly formats that may not be included in the DIP 204, such as new data format protocols, etc.) to a browser. In some embodiments, the portal server 104 may have both the SIM 604 and the DIP 204 installed. Therefore, the SIM 604 can be used to simply view raw data (in its simplest configuration). Subsequently other software modules, such as the DIP 204 or third-party modules, can be used to parse and format the data in a desired way.

### IV. Other Exemplary Embodiments

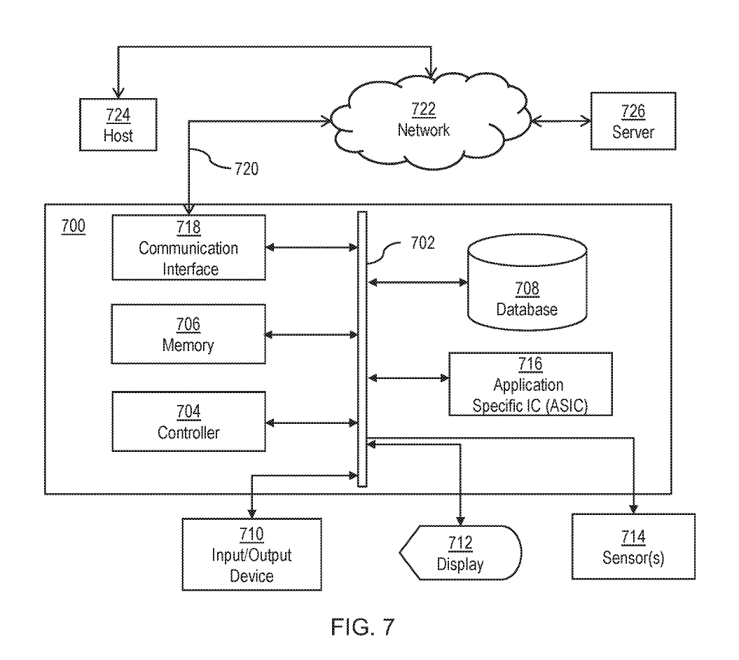

FIG. 7 illustrates a computer system 700 upon which the operation of the user 108, the DIP 204, the SIM 604, the configuration file database 206, the information database 208 and the portal server 104 may be implemented. Although, the computer system 700 is depicted with respect to a particular device or equipment, it is contemplated that other devices or equipment (e.g., network elements, servers, etc.) within FIG. 7 can deploy the illustrated hardware and components of system. The computer system 700 is programmed (e.g., via computer program code or instructions) to retrieve data from the data sources 102 described herein and includes a communication mechanism such as a bus 702 for passing information between other internal and external components of the computer system 700. Information (also called data) is represented as a physical expression of a measurable phenomenon, typically electric voltages, but including, in other embodiments, such phenomena as magnetic, electromagnetic (light, fields, etc.), pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. The computer system 700, or a portion thereof, constitutes a means for performing one or more steps retrieving data from one or more data sources 102.

A bus 702 includes one or more parallel conductors of information so that information is transferred quickly among devices coupled to the bus 702. A processor 704 for processing information are coupled with the bus 702.

The processor 704 performs a set of operations on information as specified by a user. The computer program code is a set of instructions or statements providing instructions for the operation of the processor 704 and/or the computer system 700 to perform specified functions. The code, for example, may be written in a computer programming language that is compiled into a native instruction set of the processor 704. The code may also be written directly using the native instruction set (e.g., machine language). The set of operations include bringing information in from the bus 702 and placing information on the bus 702. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 704, such as a sequence of operation codes, constitute processor instructions, also called computer system instructions or, simply, computer instructions. The processor 704 may be implemented as mechanical, electrical, magnetic, optical, chemical, or quantum components, among others, alone or in combination.

The computer system 700 also includes a memory 706 coupled to the bus 702. The memory 706, such as a Random Access Memory (RAM) or any other dynamic storage device, stores information including processor instructions for storing information and instructions to be executed by the processor 704. The dynamic memory 706 allows information stored therein to be changed by the computer system 700. RAM allows a unit of information stored at a location called a memory address to be stored and retrieved independently of information at neighboring addresses. The memory 606 is also used by the processor 704 to store temporary values during execution of processor instructions. The computer system 700 also includes a Read Only Memory (ROM) or any other static storage device coupled to the bus 702 for storing static information, including instructions, that is not changed by the computer system 700. Some memory is composed of volatile storage that loses the information stored thereon when power is lost. Also coupled to the bus 702 is a non-volatile (persistent) storage device 708, such as a magnetic disk, a solid state disk, optical disk or flash card, for storing information, including instructions, that persists even when the computer system 700 is turned off or otherwise loses power.

Information, including instructions for inspecting the XML data source query files is provided to the bus 702 for use by the controller 704 from an external input/output device 710. From an input perspective, the input/output device could include one or more elements such as a keyboard containing alphanumeric keys operated by a human user, a mouse, trackball, microphone, an Infrared (IR) remote control, a joystick, a game pad, a stylus pen, a touch screen, or any other of an input/output device. These devices can be capable of controlling a position of a small cursor image presented on the display 712 and issuing commands associated with graphical elements presented on the display 712.

From an output perspective, the input/output device 710 could include a Cathode Ray Tube (CRT), a Liquid Crystal Display (LCD), a Light Emitting Diode (LED) display, an organic LED (OLED) display, an active matrix display, an Electrophoretic Display (EPD), a plasma screen, or a printer for presenting text or images. Additionally, a separate display 712 may also include any of the previously mentioned devices or any other devices capable of visually, audibly, or even by means of touch, scent, etc. to provide output data to a user. Further, the display 712 may be a touch enabled display such as capacitive or resistive screen. In some embodiments, for example, in embodiments in which the computer system 700 performs all functions automatically without human input, one or more of the external input device 710, and the display 712 may be omitted.

Sensors 714 may be provided as components of the input/output device 710, or may be provided as independent components to the system 700. The sensor(s) 714 may detect conditions in its vicinity and transform those detections into physical expressions compatible with the measurable phenomenon used to represent information in the computer system 700 such as capturing, recording and causing to store one or more still and/or moving images (e.g., videos, movies, etc.) which also may comprise audio recordings. Sensors 714 may also detect elements such as motion, temperature, imagery or video, etc.

Other external devices can also be coupled to the bus 702 such as an Application Specific IC (ASIC) device 716. In the illustrated embodiment, special purpose hardware such as the ASIC 716 might serve as special purpose hardware configured to perform operations not performed by the controller 704 quickly enough for various purposes. Examples of ASICs include graphics accelerator cards for generating images for the display 712, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 700 also includes one or more instances of a communication interface 718 coupled to the bus 702. The communication interface 718 provides a one-way or two-way communication coupling to a variety of external devices that operate with their own processors, such as printers, scanners and external disks. In general, the coupling is with a network link 720 that is connected to a local network 722 to which a variety of external devices with their own processors are connected. For example, the communication interface 718 may be a parallel port or a serial port or a Universal Serial Bus (USB) port on a personal computer. In some embodiments, the communication interface 718 is an Integrated Services Digital Network (ISDN) card, a Digital Subscriber Line (DSL) card, or a telephone modem that provides an information communication connection to a corresponding type of a telephone line. In some embodiments, the communication interface 718 is a cable modem that converts signals on the bus 702 into signals for a communication connection over a coaxial cable or into optical signals for a communication connection over a fiber optic cable. As another example, the communication interface 718 may be a Local Area Network (LAN) card to provide a data communication connection to a compatible LAN, such as Ethernet™ or an Asynchronous Transfer Mode (ATM) network. In one embodiment, wireless links may also be implemented. For wireless links, the communication interface 718 sends or receives or both sends and receives electrical, acoustic or electromagnetic signals, including infrared and optical signals that carry information streams, such as digital data. For example, in wireless handheld devices, such as mobile telephones like cell phones, the communication interface 718 includes a radio band electromagnetic transmitter and receiver called a radio transceiver. In certain embodiments, the communication interface 718 enables connection to the communication network 106 for inspecting the user queries in the XML configuration files. Further, the communication interface 718 can include peripheral interface devices, such as a thunderbolt interface, a Personal Computer Memory Card International Association (PCMCIA) interface, etc. Although a single communication interface 718 is depicted, multiple communication interfaces can also be employed.

The term “computer-readable medium” as used herein refers to any medium that participates in providing information to the processor 704, including instructions for execution. Such a medium may take many forms, including, but not limited to, computer-readable storage medium (e.g., non-volatile media, volatile media), and transmission media. Non-transitory media, such as non-volatile media, include, for example, optical or magnetic disks, such as the storage device 708. Volatile media include, for example, the dynamic memory 706. Transmission media include, for example, twisted pair cables, coaxial cables, copper wire, fiber optic cables, and carrier waves that travel through space without wires or cables, such as acoustic waves, optical or electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a USB flash drive, a Blu-ray disk, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 716.

The network link 720 typically provides information communication using transmission media through one or more networks to other devices that use or process the information. For example, the network link 720 may provide a connection through the local network 722 to a host computer 724 or to ISP equipment operated by an Internet Service Provider (ISP).

A computer called a server host 726, connected to the Internet, hosts a process that provides a service in response to information received over the Internet. For example, the server 726 hosts a process that provides information representing video data for presentation at the display 712. It is contemplated that the components of the computer system 700 can be deployed in various configurations within other computer systems, e.g., the host 724 and the server 726.

At least some embodiments of the invention are related to the use of the computer system 700 for implementing some or all of the techniques described herein. According to one embodiment of the invention, those techniques are performed by the computer system 700 in response to the processor 704 executing one or more sequences of one or more processor instructions contained in the memory 706. Such instructions, also called computer instructions, software and program code, may be read into the memory 706 from another computer-readable medium such as the storage device 708 or the network link 720. Execution of the sequences of instructions contained in the memory 706 causes the processor 704 to perform one or more of the method steps described herein. In alternative embodiments, hardware, such as the ASIC 716, may be used in place of or in combination with software to implement the invention. Thus, embodiments of the invention are not limited to any specific combination of hardware and software, unless otherwise explicitly stated herein.

Various forms of computer readable media may be involved in carrying one or more sequence of instructions or data or both to the processor 704 for execution. For example, instructions and data may initially be carried on a magnetic disk of a remote computer such as the host 724. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 720. An infrared detector serving as the communication interface 718 receives the instructions and data carried in the infrared signal and places information representing the instructions and data onto the bus 702. The bus 702 carries the information to the memory 706 from which the processor 704 retrieves and executes the instructions using some of the data sent with the instructions. The instructions and data received in the memory 706 may optionally be stored on the storage device 708, either before or after execution by the processor 704.

### V. Alternative Embodiments

While certain embodiments of the invention are described above, and FIGS. 1 to 7 disclose the best mode for practicing the various inventive aspects, it should be understood that the invention can be embodied and configured in many different ways without departing from the spirit and scope of the invention.

For example, embodiments are disclosed above in the context of retrieving data from one or more data sources based on user queries embedded in XML configuration files. However, embodiments are intended to include or otherwise cover any type of configuration file.

Embodiments as disclosed above allow retrieval of data from different data sources and display the data as per user-defined display options and data retrieval filters through a portal server and an associated portal. Embodiments of the present disclosure further enable the portal server to be a single point of access in data retrieval and display without using any additional resources or applications on an end-user terminal.

Embodiments are also intended to cover storing retrieved data in any predefined format in a database associated with the portal server such that the data can be displayed through portlets generated by the portal server. The predefined format can be based on a type of data source and user-defined data fields provided in an XML configuration file.

Embodiments are directed to a system and a method that facilitates both periodic and aperiodic data exchange between a user terminal and one or more data sources. A single data source query can be utilized for both periodic data retrieval and aperiodic data retrieval. Embodiments also allow an end-user to specify various parameters related to periodic and aperiodic data exchange including, but not limited to, time periods, event triggers, and the like.

Embodiments are also intended to cover any form building toolkit that allows creation of forms without coding for a portal page. The forms can be used to receive options from a user and display data.

Exemplary embodiments are intended to cover all software or computer programs capable of enabling processors to implement the above operations, designs and determinations. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary embodiments disclosed above.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or subnetworks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of a network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

While the subject matter has been described in detail with reference to exemplary embodiments thereof, it will be apparent to one skilled in the art that various changes can be made, and equivalents employed, without departing from the scope of the invention. All related art references discussed in the above Background section are hereby incorporated by reference in their entirety.

What is claimed is:

1. A method for exchanging data between a user and a data source, the method comprising:
configuring a non-transitory computer readable medium to access data from the data source via a data source query in accordance with options specified in a user-defined XML configuration file, the user-defined XML configuration file further specifying a set of options, a set of data retrieval filters, a first set of options for periodic data retrieval and a second set of options for aperiodic data retrieval;
retrieving data from the data source in accordance with the data retrieval filters specified in the user-defined XML configuration file, the first set of options for periodic data retrieval and a second set of options for aperiodic data retrieval; and
displaying data in accordance with the set of options specified in the user-defined XML configuration file; and
utilizing, by the non-transitory computer readable medium, a first application that retrieves data periodically in accordance with the first set of options specified in the user-defined XML configuration file and a second application that retrieves data aperiodically in accordance with the second set of options specified in the user-defined XML configuration file.

2. The method of claim 1, wherein the first application and the second application are stored on a portal server or the user.

3. The method of claim 1, wherein data source query comprises one or more identities indicative of data source, one or more sets of keywords, and the set of options.

4. The method of claim 1, further comprising:
receiving a user-defined time period from the user;
generating the first set of options for periodic data retrieval based on the user-defined time period; and
storing the first set of options for periodic data retrieval in the user-defined XML configuration file.

5. The method of claim 1, further comprising:
determining whether data source query comprises a parameter indicative of periodic data retrieval;
generating a default time period based on the parameter indicative of periodic data retrieval; and
generating the first set of options for periodic data retrieval based on the default time period.

6. The method of claim 5, further comprising:
receiving a user-defined time period from the user;
modifying the first set of options for periodic data retrieval based on the user-defined time period; and
storing the modified first set of options for periodic data retrieval in the user-defined XML configuration file.

7. The method of claim 1, further comprising:
determining whether the data source query comprises a parameter indicative of aperiodic data retrieval;
generating an event trigger based on the parameter indicative of aperiodic data retrieval;
generating the second set of options for aperiodic data retrieval based on the event trigger; and
storing the second set of options for aperiodic data retrieval in the user-defined XML configuration file.

8. The method of claim 1, further comprising storing data in a server database in a predefined format.

9. The method of claim 1, further comprises accessing connection information stored in the user-defined XML configuration file to retrieve data.

10. The method of claim 1, further comprising displaying data on one or more portlets on a portal.

11. The method of claim 1, further comprising refreshing data displayed on the one or more portlets in accordance with the first set of options for periodic data retrieval and the second set of options for aperiodic data retrieval specified in the user-defined XML configuration file.

12. The method of claim 1, further comprising storing the user-defined XML configuration file in a memory local to the user.

13. A method of retrieving data from a data source, the method comprising:
receiving a set of options, data retrieval filters, a first set of options for periodic data retrieval and a second set of options for aperiodic data retrieval from a user via a user interface;
embedding the data retrieval filters, the set of options, the first set of options and the second set of options in the user-defined XML configuration file;
retrieving data from the data source in accordance with data retrieval filters, the first set of options and the second set of options embedded in the user-defined XML configuration file;
storing data in a database in accordance with a predefined format; and
generating one or more portlets to display data to the user in accordance with the set of options, the first set of options, the second set of options and the predefined format.

14. The method of claim 13, further comprising generating a first portlet for displaying data periodically in accordance with the first set of options.

15. The method of claim 13, generating a second portlet for displaying data aperiodically in accordance with the second set of options.

16. The method of claim 13, further comprising:
receiving a user-defined time period from the user;
generating the first set of options for periodic data retrieval based on the user-defined time period; and
embedding the first set of options for periodic data retrieval in the user-defined XML configuration file.

17. The method of claim 13, further comprising:
receiving an event trigger from the user;
generating the second set of options for aperiodic data retrieval based on the event trigger; and
embedding the second set of options for aperiodic data retrieval in the user-defined XML configuration file.

18. The method of claim 13, further comprising:
retrieving data periodically, through a first application, in accordance with the first set of options; and
retrieving data aperiodically, through a second application, in accordance with the second set of options.

19. A system for exchanging data between a user and a data source, the system comprising:
a web portal that is configured to receive a data source query from the user, data source query corresponding to the data source;
a processor that is configured to generate a user-defined XML configuration file based on the data source query, the user-defined XML configuration file including a set of options, data retrieval filters, a first set of options for periodic data retrieval and a second set of options for aperiodic data retrieval; and
a portal server communicably coupled to the web portal, the portal server configured to:
retrieve data from data source in accordance with the data retrieval filters, the first set of options and the second set of options specified in the user-defined XML configuration file;
store data in a database in accordance with a predefined format; and
generate one or more portlets to display data by the web portal in accordance with the set of options, the first set of options, the second set of options and the predefined format;

20. The system of claim 19, wherein the portal server further comprises:
a first application that is configured to retrieve data periodically in accordance with the first set of options; and
a second application that is configured to retrieve data aperiodically in accordance with the second set of options.
